(19) United States
(12) Patent Application Publication
(10) Pub. No.: US 2003/0174144 A1
(43) Pub. Date: Sep. 18, 2003

(54) Method for adjusting color value or related parameters of overlay image frame

(75) Inventor: Chi-Yang Lin, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Via Technologies, Inc., Taipei (TW)

(21) Appl. No.: 10/207,587

(22) Filed: Jul. 29, 2002

(30) Foreign Application Priority Data
Mar. 15, 2002 (TW) 091104889

(51) Int. Cl. G09G 5/02

(52) U.S. Cl. 345/600

(57) ABSTRACT

A method for adjusting a color value of an overlay image frame for use in a system including a digital image processing device and a display device is disclosed. The method includes the steps of revealing an overlay image frame on the display device, and adjusting a color value of the overlay image frame by the digital image processing device in response to a triggering of a hot-key input signal.

### FIELD OF THE INVENTION

The present invention relates to a method for adjusting a color value or related parameters of an overlay image frame, and more particularly to a method for adjusting a color value or parameters of an overlay image frame for use in a system including a digital image processing device and a display device.

### BACKGROUND OF THE INVENTION

Please refer to FIG. 1 which is a partial functional block diagram illustrating a conventional image processing and display device of a computer. A graphic chip 10 includes an on-screen frame buffer 101 and an overlay frame buffer 102. An overlay engine 11 accesses pixel data from the on-screen frame buffer 101 and the overlay frame buffer 102, respectively. The pixel data is processed by an overlay operation and then outputted to a random access memory digital-to-analog converter (RAM DAC) 12 to be converted into analog signals suitable for being displayed on a computer display 13.

Please refer to FIG. 2 which is a schematic diagram illustrating a frame of the computer display 13 in an overlay mode. The pixel data of the on-screen frame buffer 101 is revealed in a region 20 while that of the overlay frame buffer 102 is revealed in a region 21. Furthermore, the size of the region 21 is adjustable. For example, when the computer plays a digital versatile disc (DVD), a desktop image stored in the on-screen frame buffer 101 is showed in the region 20 and the DVD image stored in the overlay frame buffer 102 is showed in the region 21. Generally, since the color properties of the region 20 and the region 21 are different, e.g. the image shown in the region 21 is relatively darker, it is desired that the luminance, hues and gamma values of the image in the region 21 can be adjusted. Conventionally, those parameters are adjusted by a display software via some graphic user interfaces (GuIs) such as selection items 22 and adjusting buttons 23 in the frame. By this method, the image color values in region 21 can be adjusted independently from the original settings of the computer display 13.

However, when the region 21 is enlarged to be a full-screen scale, the above GUIs for adjusting purposes will be hidden and cannot be used. Thus, it causes the difficulty in operation for the user.

Therefore, the purpose of the present invention is to develop a method for adjusting a color value or related parameters of overlay image frame to deal with the above situations encountered in the prior art.

### SUMMARY OF THE INVENTION

An object of the present invention is to provide a method for adjusting a color value or related parameters of an overlay image frame quickly and conveniently.

According to an aspect of the present invention, there is provided a method for adjusting a color value of an overlay image frame for use in a system including a digital image processing device and a display device. The method includes the steps of revealing an overlay image frame on the display device, and adjusting a color value of the overlay image frame by the digital image processing device in response to a triggering of a hot-key input signal.

Preferably, the digital image processing device reveals an input interface on the display device for adjusting the color value of the overlay image frame in response to the triggering of the hot-key input signal.

Preferably, the hot-key input signal is outputted by pressing a key of a keyboard or a mouse.

For example, the digital image processing device can be a computer host and the display device can be a computer display.

Preferably, the overlay image frame is a full-screen overlay image frame.

According to another aspect of the present invention, there is provided a method for adjusting parameters of an overlay image frame for use in a system including a digital image processing device and a display device. The method includes the steps of revealing an overlay image frame on the display device, and adjusting parameters of the overlay image frame by the digital image processing device in response to a triggering of a hot-key input signal.

Preferably, the digital image processing device reveals an input interface on the display device for adjusting the parameters of the overlay image frame in response to the triggering of the hot-key input signal.

For example, the parameters can include color values or/and the size of the overlay image frame or the volume played along with the overlay image frame.

### BRIEF DESCRIPTION OF THE DRAWINGS

The present invention may best be understood through the following description with reference to the accompanying drawings, in which:

FIG. 1 is a partial functional block diagram illustrating a conventional image processing and display device of a computer;

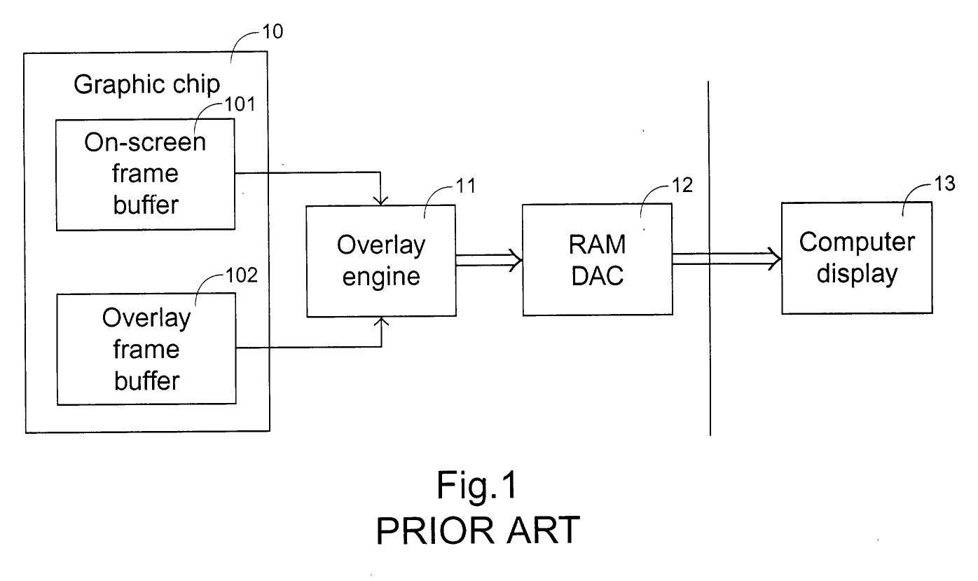

FIG. 2 is a schematic diagram illustrating a frame of the computer display of FIG. 1 in an overlay mode;

FIG. 3 is a partial functional block diagram illustrating a preferred embodiment of a method for adjusting color values or related parameters of overlay image frame for use in an image processing and display device of a computer according to the present invention; and

FIG. 4 is a schematic flowchart illustrating the method for adjusting color values or related parameters of overlay image frame of FIG. 3.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

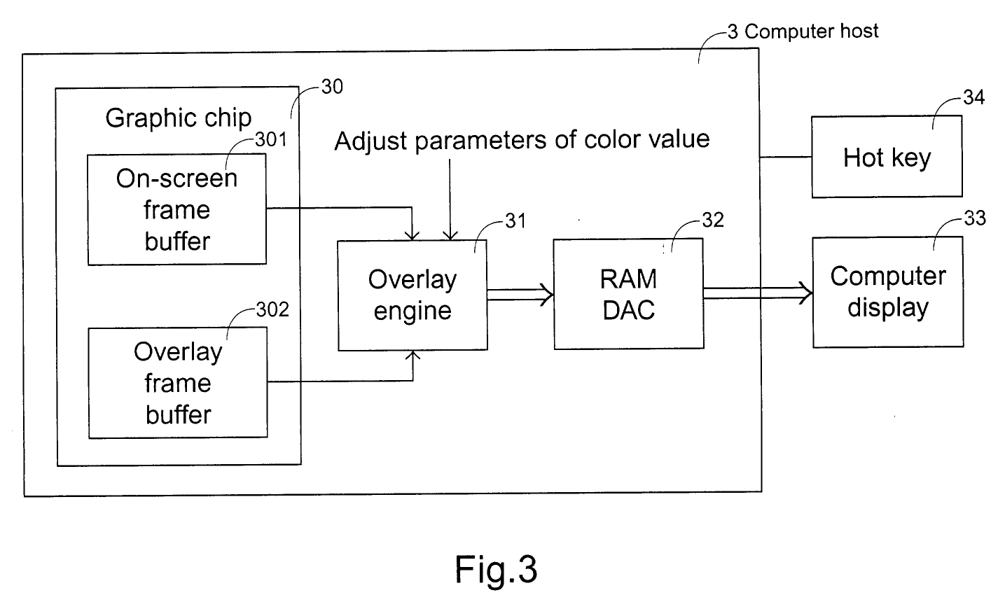

Please refer to FIG. 3 which is a partial functional block diagram illustrating a preferred embodiment of a method for adjusting color values or related parameters of overlay image frame for use in an image processing and display device of a computer according to the present invention. A graphic chip 30 in a computer host 3 includes an on-screen frame buffer 301 and an overlay frame buffer 302. An overlay engine 31 accesses pixel data from the on-screen frame buffer 301 and the overlay frame buffer 302, respectively. The pixel data is processed by an overlay operation and then outputted to a random access memory digital-to-analog converter (RAM DAC) 32 to be converted into analog signals suitable for being displayed on a computer display 33.

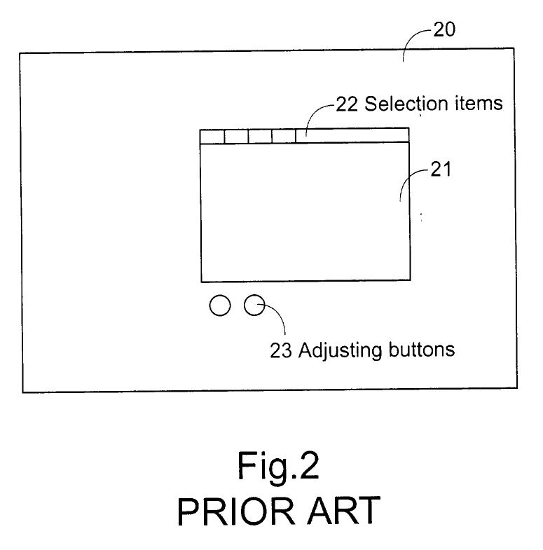

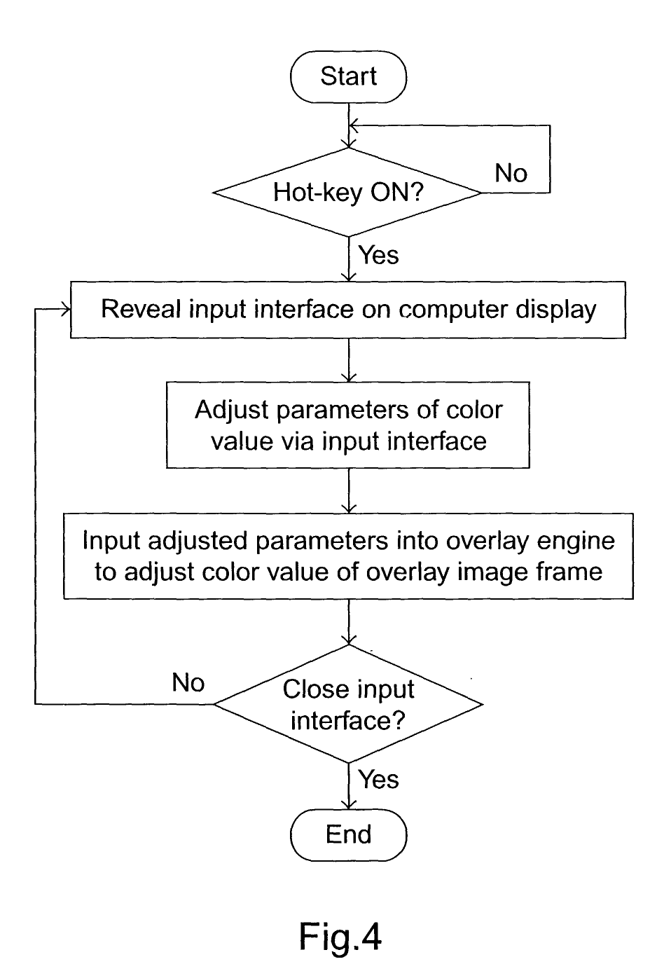

For adjusting the color values of the overlay image frame in the computer display 33, it is necessary to modify the adjusting parameters of the driver transmitted to the overlay engine 31. The flowchart of the method for adjusting the color value of the overlay image frame is shown in FIG. 4. When the overlay image frame is revealed on the computer display, an input interface such as GUI for the color value adjustment is revealed on the computer display, as shown in FIG. 2. Even if a full-screen image is displayed, the GUI buttons can still be revealed by pressing a hot-key 34. The term “hot-key” is a general term known to those skilled in the art. For example, it can be a key of the keyboard or the mouse, or a combination of buttons of the keyboard. Subsequently, the user can adjust the parameters of the color value via the input interface. The adjusted parameters of the color values are inputted into the overlay engine 31 for adjusting the color values of the overlay image frame. The input interface for adjusting the color value can be closed at any time when it is not required any more, and can be recalled to be shown on the computer display by pressing the hot key once again. In addition to the color values, the size of the overlay image frame or the volume played along with the overlay image frame can also be adjusted by the method according to the present invention.

To sum up, the method for adjusting the color value or the related parameters of the overlay image frame according to the present invention can quickly and conveniently call out an input interface by pressing a hot-key, even though the GUIs for adjusting purpose is hidden.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for adjusting a color value of an overlay image frame for use in a system including a digital image processing device and a display device, comprising the steps of:
revealing an overlay image frame on said display device; and
adjusting a color value of said overlay image frame by said digital image processing device in response to a triggering of a hot-key input signal.

2. The method according to claim 1 wherein said digital image processing device reveals an input interface on said display device for adjusting said color value of said overlay image frame in response to said triggering of said hot-key input signal.

3. The method according to claim 1 wherein said hot-key input signal is outputted by pressing a key of a keyboard.

4. The method according to claim 1 wherein said hot-key input signal is outputted by pressing a key of a mouse.

5. The method according to claim 1 wherein said digital image processing device is a computer host and said display device is a computer display.

6. The method according to claim 1 wherein said overlay image frame is a full-screen overlay image frame.

7. A method for adjusting a plurality of parameters of an overlay image frame for use in a system including a digital image processing device and a display device, comprising the steps of:
revealing an overlay image frame on said display device; and
adjusting parameters of said overlay image frame by said digital image processing device in response to a triggering of a hot-key input signal.

8. The method according to claim 7 wherein said digital image processing device reveals an input interface on said display device for adjusting said parameters of said overlay image frame in response to said triggering of said hot-key input signal.

9. The method according to claim 8 wherein said parameters include color values of said overlay image frame.

10. The method according to claim 8 wherein said parameters include a size of said overlay image frame.

11. The method according to claim 8 wherein said parameters include a volume played along with said overlay image frame.

12. The method according to claim 7 wherein said hot-key input signal is outputted by pressing a key of a keyboard.

13. The method according to claim 7 wherein said hot-key input signal is outputted by pressing a key of a mouse.

14. The method according to claim 7 wherein said digital image processing device is a computer host and said display device is a computer display.

15. The method according to claim 7 wherein said overlay image frame is a full-screen overlay image frame.
